(19) United States
(12) Patent Application Publication
(10) Pub. No.: US 2006/0000127 A1
(43) Pub. Date: Jan. 5, 2006

(54) Pocket card

(76) Inventor: Jayne Schindele, Boise, ID (US)

Correspondence Address: ROBERT L. SHAVER;DYKAS, SHAVER & NIPPER LLP, PO BOX 877, BOISE, ID, 83701-0877, US

(21) Appl. No.: 11/070,442

(22) Filed: Mar. 1, 2005

Related U.S. Application Data
(60) Provisional application No. 60/583,983, filed on Jun. 30, 2004.

(51) Int. Cl. G09F 1/00

(52) U.S. Cl. 40/124.06

(57) ABSTRACT

A pocket card including at least one pocket as fastened to one or more covers or other pockets for allowing a variety of inserts to be stored therein.

### PRIORITY

This application claims the priority date of the provisional application entitled Pocket Card filed by Jayne Schindele on Jun. 30, 2004 with application Ser. No. 60/583,983.

### BACKGROUND OF THE INVENTION

1. Field of the Invention

The present invention generally relates to the field of gift cards. More particularly, the present invention provides a greeting card that includes a pocket on an external surface of a pocket gift card, which may be used to hold a variety of inserts.

2. Background Information

Both individuals and businesses often give greeting cards for birthdays, holidays, and other occasions to express a feeling or emotion. Greeting cards are also commonly used to make various types of announcements such as for new products, business notices, graduations, births, birthdays and marriages. Inserts are commonly given in conjunction with the greeting card. Inserts, such as gift certificates, poems and photographs are used to personalize and enhance the significance of the greeting card. In some cases, the insert or photo does not reflect upon the theme of the greeting card and may tend to fall out of the greeting card when read. There is a need in the art for a greeting card that easily and properly holds an insert. Such a greeting card or pocket card should be functional, stylish and aesthetically pleasing. Accordingly, it is an object of the present invention to provide a stylish pocket greeting card for allowing a variety of inserts. It is a further object of the present invention to provide an insert retention device that allows the insert to be removed from the top, bottom or either side of the pocket card.

Additional objects, advantages, and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

The pocket card of the invention can take a number of forms, all within the inventive concept of a greeting card with a pocket. One embodiment of the present invention provides a pocket card including a single piece of material and a pocket attached on two or more edges to an exterior surface of the single piece of material, with a card insert for placement in the pocket.

In another embodiment, the present invention provides a pocket card made from a piece of material folded, with a pocket on any surface of the folded piece.

The pocket card can include a front cover having a front exterior surface and a front inner surface, and a pocket for holding an insert fastened to the front exterior surface of the front cover.

In another embodiment, the present invention provides a pocket card including a front cover having a front exterior surface and a front inner surface, a pocket attached to the front exterior surface for holding an insert, and a back cover hingedly connected to the front cover having a back inner surface and a back exterior surface.

Another embodiment of the present invention provides a pocket card including a front cover having a front exterior surface and a front inner surface, a back cover hingedly connected to the front cover having a back inner surface and a back exterior surface, and a pocket for holding an insert fastened to the front inner surface of the back cover. In this and any of the described embodiments, the opening of the pocket can be oriented in any direction, and may be a pocket formed with one or two sides open for the insert to slip into the pocket. The card may be configured so that the card opens like a book, with the spine vertical, or may be configured so the spine is horizontal and the front cover flips up to reveal that pocket on either of the interior faces, oriented in any direction.

Another embodiment of the present invention provides a pocket card including a front cover having a front exterior surface and a front inner surface, a back cover hingedly connected to the front cover having a back inner surface and a back exterior surface, and a pocket for holding an insert fastened to the back inner surface of the back cover.

Another embodiment of the present invention provides a pocket card including a front cover having a front exterior surface and a front inner surface, a back cover hingedly connected to the front cover, the back cover having a back inner surface and a back exterior surface. It includes at least one pocket, the pocket having a top, bottom, left and right side for holding an insert. The pocket may be fastened to the back inner surface of the back cover, with at least two sides of the pocket attached to the back inner surface allowing the insert to be removed from the top, bottom, left or right side of the pocket, on the front cover or the back cover. The pocket may be decorated with any writing, drawings, symbols, ribbons, bows, mementos, keepsakes or fabric. The pocket card may be the same size or smaller than the back cover. The pocket card may also include cutouts within any of the front cover, the back cover, the pocket or the insert. The insert may be any of a greeting card, gift certificate, envelope, letter, blank paper, picture, poem or message.

The pocket card may include at least one pocket on any of the front cover, the back cover, or on a pocket, or on an insert for another pocket. These pockets may also be nested pockets, with one pocket attached to another pocket or the insert. The pocket card may be used as a greeting card, gift card, thank you card, flower card, invitation, or other uses typically associated with cards. The pocket may be decorated with any of ribbons, bows, drawings, symbols, mementos, ornaments, fabric, keepsakes, foil, colors, poems, sayings, writings or papers. The pocket card may be wrapped with fabric providing aesthetically pleasing look while preventing the fabric from fraying. The pockets may be oval, circular, rectangular, triangular, asymmetric, symmetric, or other shapes. The pocket cover may have multiple covers hingedly fastened to the front cover and the back cover. A pocket card with many covers may have multiple covers with at least one or more of the pockets attached to more than one cover. It may also open in an accordion or three-surfaced wallet fashion, with pockets possible on any of the surfaces. The insert may be folded over, and have a pocket and another insert on the first insert.

The purpose of the foregoing Abstract is to enable the United States Patent and Trademark Office and the public generally, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 is a front view of one preferred embodiment of a pocket card.

FIG. 2 is a front view of another preferred embodiment of the pocket card.

FIG. 3 is a front view of another preferred embodiment of the pocket card.

FIG. 4 is a perspective view of another preferred embodiment of the pocket card shown opened.

FIG. 5 is a perspective view of another preferred embodiment of the pocket card shown opened.

FIG. 6 is a perspective view of another preferred embodiment of the pocket card shown opened.

FIG. 7 is a perspective view of another preferred embodiment of the pocket card shown opened.

FIG. 8 is a perspective view of another preferred embodiment of the pocket card shown opened.

FIG. 9 is a perspective view of another preferred embodiment of the pocket card shown opened.

FIG. 10 is a perspective view of another preferred embodiment of the pocket card shown opened.

FIG. 11 is a perspective view of another preferred embodiment of the pocket card shown opened.

FIG. 12 is a perspective view of one embodiment of the pocket card.

FIG. 13 is one preferred embodiment of the pocket card.

FIG. 14A is a perspective view showing how one version of the pocket card can be constructed.

FIG. 14B is a side view of one version of the pocket card of the invention.

FIG. 15A is diagram showing how one version of the pocket card of the invention can be made.

FIG. 15B is a side view showing one embodiment of the pocket card.

FIG. 15C is a diagram showing one method of making one embodiment of the pocket card of the invention.

FIG. 16 is another perspective view of the invention.

### DESCRIPTION OF THE PREFERRED EMBODIMENTS

While the invention is susceptible to various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

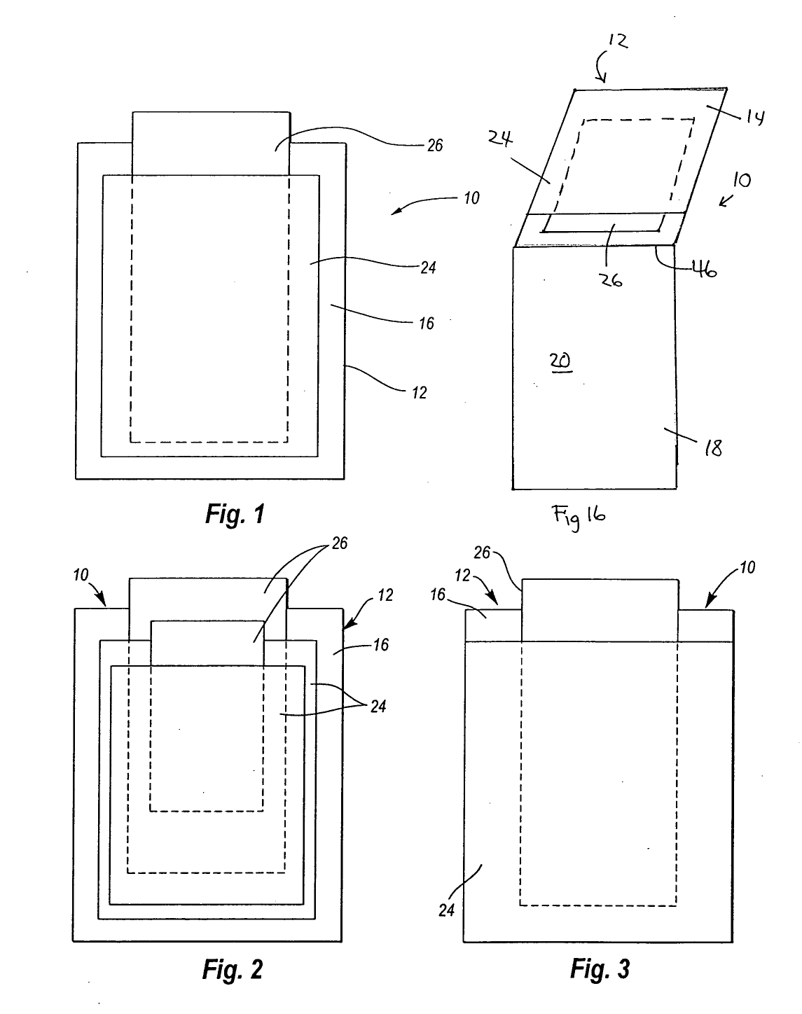

Some of the preferred embodiments of the present invention are shown in FIGS. 1-15C. FIG. 1 is a front view of one preferred embodiment of a pocket card. The pocket card 10 is a greeting style card or single cover that includes a pocket 24 on an external surface of the card, which can be used to hold an insert 26. The pocket card 10 includes at least one cover from which a pocket 24 is formed or to which at least one pocket 24 may be attached. In some embodiments, the pocket card may have multiple covers or pages and may have multiple pockets, with at least one pocket and as many as one or more per cover. The pocket card 10 is preferably formed from a paper product, but could also be created using fabric, plastic, thin metal, or other similar materials.

The embodiment shown in FIG. 1 is a front cover 12 with a pocket 24 fastened to a front exterior surface 16 of the front cover 12. The pocket 24 of the present invention is filled with an insert 26 that is shown protruding from the pocket 24 and held within the pocket 24. The pocket 24 is preferably connected to the front exterior surface 16 of the front cover 12 on at least two sides or edges. Some preferred edge attachment schemes include: attaching the two side edges, attaching the top and bottom edges, attaching either side edge and the bottom edge, attaching both side edges and the bottom edge, attaching the top and bottom edge and one side edge, and various other configurations that are not specifically indicated. A pocket for an insert may also be present on the insert that goes in another pocket.

The pocket protrudes from the front cover 12 in some embodiments, allowing larger inserts 26 to be utilized. In yet other embodiments, the pocket 24 is nearly flush with the front cover and may be formed by a piece of material attached to the front cover on at least two edges. Pocket 24 sizes may vary according to the desired insert 26 sizes. In the present embodiment, the pocket 24 is a rectangular shape. In additional embodiments, the pocket 24 may be oval, circular, square, triangular, asymmetric, symmetric, or any other shape that may be fastened to the pocket card 10 in order to form an insert receptacle. The insert 26 and covers are also not limited to a particular shape, configuration, size or color. The covers used, the insert 26, and pocket 24 all may be of any size and need not correspond with one another. In some embodiments, it is preferable that the front cover 12 and pocket be substantially smaller than a back cover of the pocket card 10. In another embodiment, a cover may be covered by fabric for decoration purposes and sealed on a backmost portion of the cover in order to prevent the fabric from unraveling or tearing. In a similar embodiment, a cover that has been covered and sealed with fabric may then be covered with a frame or cutout cover providing a unique framed fabric style that prevents the fabric used from fraying. In some embodiments, the insert 26 and covers may have cutout portions to further enhance the aesthetic appeal of the pocket card 10.

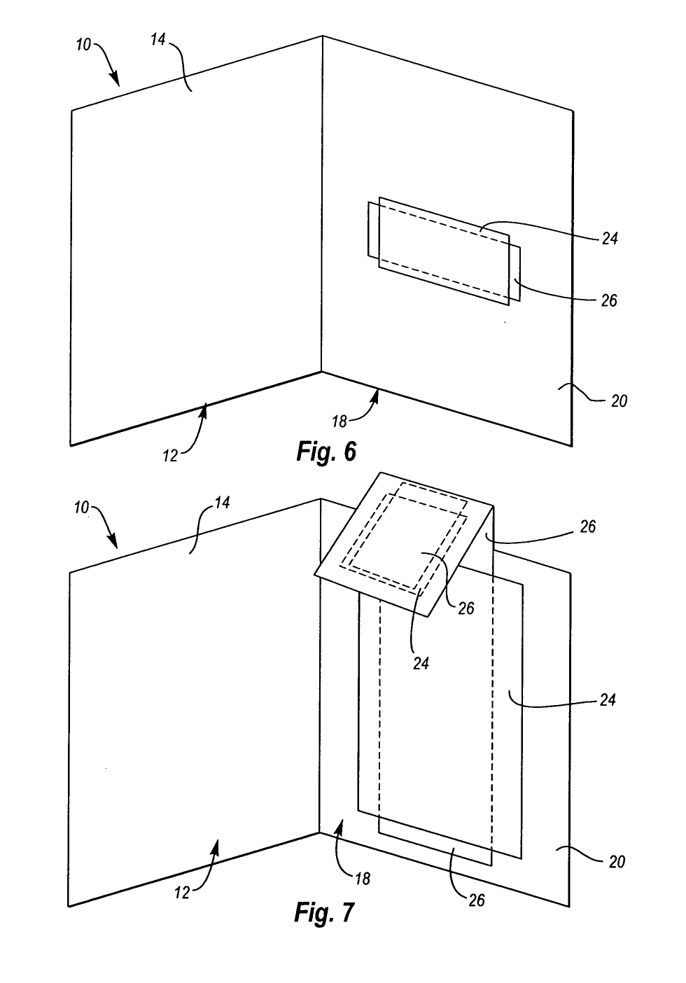

In one preferred embodiment, the pocket 24 is secured on a left and right side of the pocket 24 allowing the insert 26 to be exposed from the top portion of the pocket 24 or bottom portion of the pocket 24, as well as allowing the insert 26 to be removed from either direction. This configuration is shown in FIG. 7. An insert 26 as herein defined is any item such as a gift certificate, photograph, keepsake, message, poem, memento, greeting card, envelope, or other item that is commonly given with a card. Such an insert 26 may be personalized with writing, symbols, and decorations corresponding with a desired message or theme or may be left blank and used strictly for decoration.

FIG. 2 is a front view of another preferred embodiment of the pocket card. In this embodiment, the pocket card 10 includes multiple pockets 24 and multiple inserts 26. Multiple inserts 26 allow multiple messages or other materials to be given to a recipient in a single pocket card 10. The first pocket 24 includes a second nested pocket 24 that is similarly attached allowing an insert 26, as previously described, to be similarly inserted into the pocket card 10. By way of example, a gift giver might decide to place a standard greeting card as a first insert 26 within one pocket 24 of the pocket card 10 and additionally place a restaurant gift certificate in a second pocket 24 of the same pocket card 10. In FIGS. 1 and 2, the pocket 24 portion of the pocket card 10 is slightly smaller than the front cover 12, which may be aesthetically desirable if the pocket 24 and front cover 12 are of different colors or for other decoration purposes.

FIG. 3 is a front view of an additional embodiment of the pocket card 10. In this embodiment, the pocket 24 is the same size as the front cover 12. An insert 26 is shown as positioned in the pocket 24 of the present embodiment. Additionally, this embodiment may actually be formed by a single piece of material folded to form a pocket 24 in which the bottom of the pocket may or may not be sealed together.

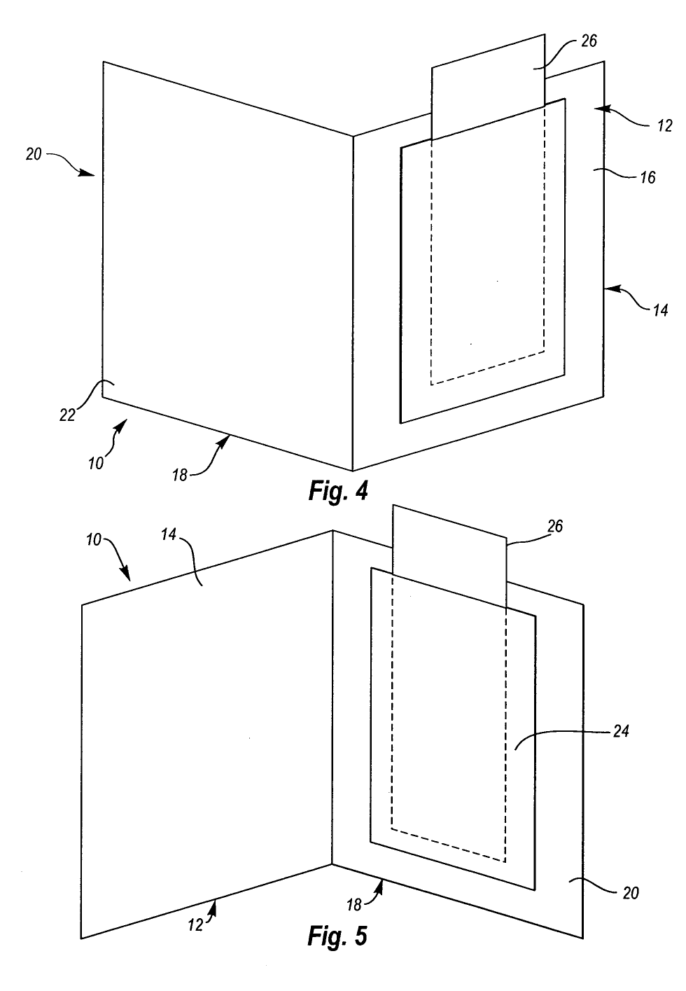

FIG. 4 is a front view of another preferred embodiment shown as an open pocket card. In this embodiment, the pocket card 10 includes a front cover 12 with an attached pocket 24. The front cover 12 has both a front interior surface 14 and a front exterior surface 16. Hingedly attached to the front cover 12 is a back cover 18 also having a back inner surface and a back exterior surface. The inner surface of both the front cover 12 and back cover 18 corresponds in size to the portion of the pocket card 10 that is not visible when closed, similar to the interior pages of a book. The back cover 18 has a back interior surface 20 and a back exterior surface 22. In one embodiment, the front cover 12 and back cover 18 are formed from a single piece of material. Additionally, the front cover 12 and back cover 18 can be fastened to form a hinge using ribbon, fabric, glue, or other hinging element. In this embodiment, an insert 26 may be inserted into the pocket 24 on the front cover 12. This allows a pocket card 10 giver to customize the pocket card 10 by writing or drawing a message on the front interior surface 14 or back interior surface of the pocket card 10. Multiple covers, such as front cover 12 and back cover 18, allow the pocket card 10 to be left in a standing or upright position so that it can be left standing as a decoration or ornament.

FIG. 5 is a perspective view of another preferred embodiment of the pocket card shown opened. In this embodiment, the pocket 24 is fastened to the pocket card 10 on the back interior surface 20. The recipient of the pocket card 10 must open the pocket card 10 in order to see the pocket 24. The insert 26 may be positioned within the pocket 24 so that it is hidden from view or may extrude from the pocket 24 as part of the appearance of the pocket card 10. Depending on the desired look and effect, a user could opt to hide the insert 26 within the pocket 24 or have it extrude from the pocket card 10 so that a recipient would immediately be able to withdraw the insert 26 to admire it or ascertain its content. The card of FIG. 5 is shown oriented with the spine 46 vertical, like a book. It could also be oriented with the spine horizontal as shown in FIG. 16, so the front would be flipped up to reveal the pocket and a message inside the card. The pocket could be positioned on any surface of this card, and oriented in any direction. A preferred configuration is to have the spine horizontal, with a pocket on the front cover interior surface, and with the pocket open for insertion of an insert adjacent to the spine.

FIG. 6 is a perspective view of another preferred embodiment of the pocket card shown opened. In this embodiment, the pocket 24 is attached to the back interior surface 20 of a folding card. The pocket 24 is attached to the back interior surface 20 on the topmost and bottommost side of the rectangular pocket 24. This allows the insert 26 to slide out of the pocket 24 from either the left or right side, and to extend beyond the edge of the covers if desired.

FIG. 7 is a perspective view of another preferred embodiment of the pocket card shown opened. This embodiment shows the insert 26 extruding from the bottommost portion of the pocket 24. In this configuration, the pocket 24 is sealed to the back interior surface on the left and right sides of the pocket 24 edge. The insert 26 may then be removed from the top or bottom of the pocket card 10. The insert 26 is shown protruding at the bottom of the pocket 24 as previously described. FIG. 7 also shows that the insert 26 can be folded with an additional pocket and insert attached to the first insert.

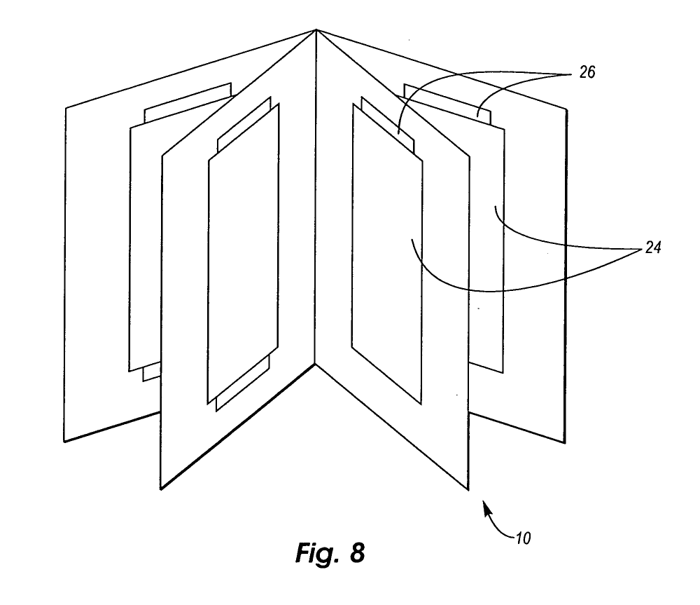

FIG. 8 is a perspective view of another preferred embodiment of the pocket card shown opened. In this embodiment, the pocket card 10 has a number of covers. Additionally, there are multiple pockets 24 within the pocket card 10 and corresponding covers. Such a pocket card may be useful for giving multiple gift certificates, photos or messages.

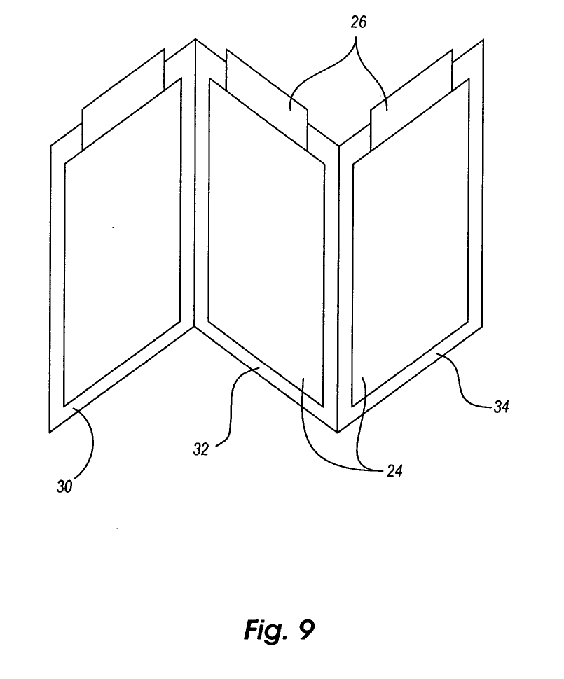

FIG. 9 is a perspective view of an additional embodiment of the pocket card shown opened. In this embodiment, the pocket card 10 is accordion shaped with a first 30, second 32 and third 34 cover or panel. This allows the pocket card 10 to be folded and condensed as needed. Attached to an exposed surface of the pocket card 10 is a pocket 24 and corresponding insert 26. This embodiment allows multiple pockets 24 to be attached to each cover. For example, if a gift giver desired to give multiple pictures or multiple gift certificates to a recipient, he/she could place each insert 26 in a corresponding pocket 24 of the pocket card 10. As with the previous figures, there is no limitation as to how many covers and corresponding pockets 24 a pocket card 10 could have.

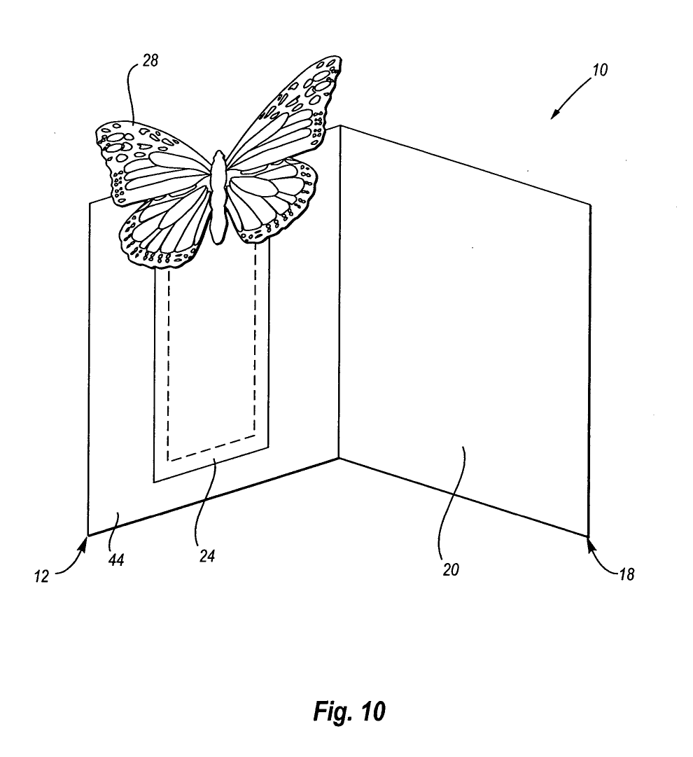

FIG. 10 is a front view of an additional embodiment of the pocket card shown opened. In this embodiment, the insert 26 is shaped at a topmost portion like a butterfly. This shape is an example that the card 26 can include decorative shapes, as well as cloth, lace, colors, perforations, or other decorative features. Each insert 26, as previously mentioned, may be customized to match or fit the theme of the pocket card 10. In one embodiment, the decoration 28 that is an inherent part of the insert 26 may allow it to be positioned on an outer portion of the front cover 12 with the connection between the decoration 28 and the insert 26 abutting the top edge of the pocket 24 in this case and the main body of the insert 26 being positioned in the pocket 24 allowing a novel aesthetic look.

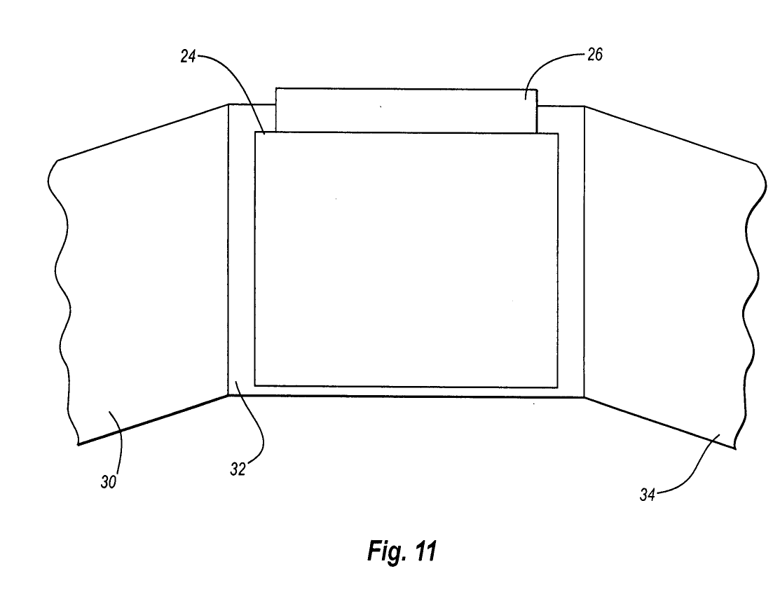

FIG. 11 is an open view of an additional embodiment of the pocket card shown opened. In this embodiment, the pocket card 10 includes first 30, second 32 and third 34 covers or panels that open in a wallet fashion. As shown in the present invention, a pocket 24 is attached to an inner surface of the second cover 32 requiring the pocket card 10 to be opened from either side to show the contents of the pocket 24 and corresponding insert 26. Additionally, the pocket can be attached to the first cover 30 or the third cover 34.

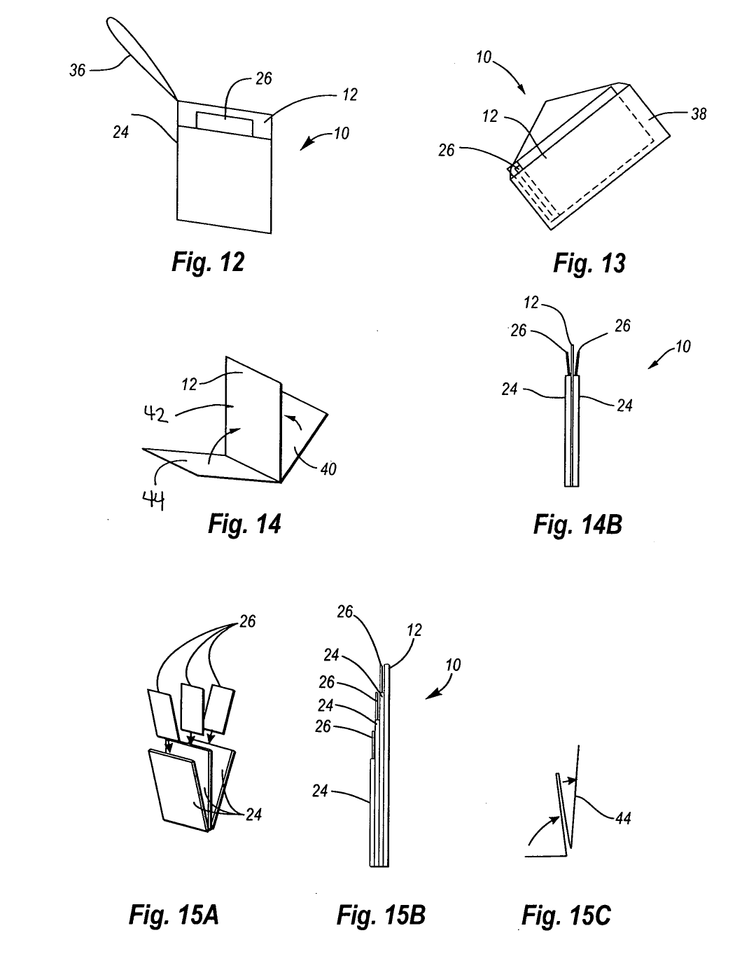

FIG. 12 shows another embodiment of the invention which includes a pocket card 10 with a pocket 24, an insert 26, a front cover 12, and a means of attachment 36. The pocket card of this configuration can be used to include a message on gifts, flower presentations, or attached to objects. It can include an envelope 38 as shown in FIG. 13 as part of the pocket card. An envelope 38 would be appropriate for flowers or other gifts where the message is meant to be confidential.

FIG. 14B shows a side view of one embodiment of the invention, which includes a front cover 12, with a pocket 24 on one side and a pocket 24 on the other side. Each pocket 24 has an insert 26 and thus this pocket card has a pocket on either side of the card. FIG. 14A shows one method of making such a card, and that is by folding a first piece 40 around the front cover 12. The edges of the first piece 40 would then be sealed to the corresponding edges of the front cover 12, in order to form the pockets 24.

FIG. 15B shows another embodiment of the pocket card 10 that includes a front cover 12 with three attached pockets 24. Each pocket 24 includes an insert 26. FIG. 15A shows one method of making such a card, which is to use a first piece 40, which is folded in half, and a second piece 42, also folded in half. The first piece and the second piece are joined together at the fold, and their edges are joined to the adjacent edge, thus forming a first, second and third pocket with our four placement of inserts 26. FIG. 15C shows an alternate method of making a multiple pocket card, and that is by folding a third piece 44, which is one single sheet which is folded in three places with the corresponding edges then joined to form multiple pockets.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

I claim:

1. A pocket greeting card comprising:
a single piece of stock material;
a pocket attached on two or more edges to an exterior surface of said single piece of material, said pocket for securing an insert; and
an insert, for conveying a message to the recipient of said card.

2. The pocket greeting card of claim 1, which further comprises a piece of stock material which is folded to form a front cover and a back cover, with a front cover inner surface and front cover exterior surface, and a rear cover inner surface and a rear cover exterior surface, with said pocket positioned on one or more surfaces of said front or rear covers, with said pocket configured to hold said insert.

3. The pocket card of claim 1 in which said pocket is decorated with any of writing, drawings, symbols, ribbons, bows, mementos, keepsakes or fabric.

4. The pocket card of claim 2, wherein said front cover is substantially smaller than said back cover.

5. The pocket card of claim 1, wherein said pocket is attached on at least two edges of said pocket.

6. The pocket card of claim 2, wherein said pocket is the same size as said back cover.

7. The pocket card of claim 2, further comprising cutouts within any of said front cover, said back cover, said pocket or said insert.

8. The pocket card of claim 1, wherein said insert is any of a greeting card, gift certificate, envelope, photo, letter, blank paper, picture, poem or message.

9. The pocket card of claim 2, further comprising at least one pocket on any of said front cover, said back cover or said pocket.

10. The pocket card of claim 1, wherein said pocket is wrapped with fabric providing aesthetically pleasing looks while preventing said fabric from fraying.

11. The pocket card of claim 1, where said pocket further comprises one or more attached pockets attached to said pocket, with each pocket configured to hold an insert.

12. The pocket card of claim 1, wherein said pocket is any of oval, circular, rectangular, triangular, asymmetric, symmetric, or other shape.

13. The pocket card of claim 2, further comprising a plurality of covers hingedly fastened to said front cover and said back cover.

14. The pocket card of claim 13, wherein each of said plurality of covers has at least one or more of said pockets attached.

15. The pocket card of claim 13, wherein said pocket card opens in an accordion fashion.

16. The pocket card of claim 13, wherein said pocket card opens in a three-panel wallet fashion.

17. The pocket card of claim 1 in which said insert includes an attached pocket, with said attached pocket configured to hold an insert.

18. Same as 17, but depends from claim 2.

19. The pocket card of claim 1 in which said insert further comprises a folded piece.

20. The pocket card of claim 19, in which said insert further includes an attached pocket, configured to hold an additional insert.

21. Same as 19, depends from claim 2.

22. Same as 20, depends from claim 2.

23. The pocket greeting card of claim 2, which further comprises a piece of stock material which is folded to form a front cover and a back cover joined by a spine, and configured for said spine to be oriented horizontally, with a front cover inner surface and front cover exterior surface, and a rear cover inner surface and a rear cover exterior surface, with said pocket positioned on one or more surfaces of said front or rear covers, with said pocket configured to hold said insert, and for said pocket to present one or more openings for insertion of an insert.

24. The pocket greeting card of claim 23, in which said pocket is on said front cover inner surface, with an opening to said pocket adjacent to said spine, for insertion of an insert.
